(19) United States
(12) Patent Application Publication
(10) Pub. No.: US 2008/0148057 A1
(43) Pub. Date: Jun. 19, 2008

(54) Security token

(75) Inventor: Gregory HAUW, Singapore (SG)

Correspondence Address: LAW OFFICES OF THOMAS E. SCHATZEL;A Professional Corporation, 16400 Lark Avenue, Suite 240, Los Gatos, CA, 95032-2564, US

(73) Assignee: OHANAE, INC.

(21) Appl. No.: 12/002,705

(22) Filed: Dec. 18, 2007

Related U.S. Application Data
(60) Provisional application No. 60/870,671, filed on Dec. 19, 2006.

(51) Int. Cl. H04L 9/32

(52) U.S. Cl. 713/185

(57) ABSTRACT

A security method comprises initiating a security token with a particular user through a personal computer client by accepting a personal identification number (PIN) as a code1 input, wherein a user is expected to remember the PIN in later accesses of the servers. And, generating a master key as code2 which does not need to be remembered by the user. Then, encrypting the code2 with a symmetric key cipher, using the code1 input as an encryption key, and storing the ciphertext in the security token. Later, registering the user with a USER_ID at a server with a SERVER_ID, and a password. And, obtaining the PIN from the user as a code1 which is used as a decryption key to decrypt the ciphertext back to its original code2. And, computing the password from the USER_ID, SERVER_ID, and code2. Afterwards, logging-on the user with a USER_ID at a server with a SERVER_ID, and a password.

### RELATED APPLICATIONS

This Application claims benefit of U.S. Provisional Patent Application, Ser. No. 60/870,671, filed Dec. 19, 2006, and titled, Method and Apparatus for Remote User Authentication to a Plural Number of Servers.

### BACKGROUND OF THE INVENTION

1. Field of the Invention

The present invention relates to network user security, and in particular to software, methods, systems, and devices for improving the strength and protection of user passwords for many servers while simplifying user access with a secure master key and security token.

2. Description of the Prior Art

The Internet has evolved from a platform for static content viewing to an interactive world where all types of personal and business transactions are possible. Invariably, going online involves logging onto various special purpose Internet servers so the user can be authenticated. Each server typically has its own rules for what can be an acceptable user ID and how the corresponding password can be constructed. Users often try to register at all the sites with the same user ID's and passwords, to make it more practical to remember them all and not have to write them down. But of course, simple, repeated user ID's and passwords make hacking them easier and more devastating to the user when they are hacked.

Hackers seek making a profit, or wreaking financial havoc, rather than just demonstrating they are clever enough to break in. So financial websites, and even credit card issuers, especially have taken to implementing a variety of security measures. Many of these involve stronger passwords, sitekeys, and security tokens that generate use-once password extensions.

Past hacker attacks were conducted by individuals and small groups. Recent attacks are getting more coordinated and sustained, and organized crime groups are more and more responsible. The Computer Security Institute (CSI) reported in 2007 that financial fraud overtook virus attacks as the source of the greatest financial loss. Virus losses fell to second place, they had been the leading cause of loss for seven straight years. Another significant cause of loss was system penetration by outsiders. Almost one-fifth of respondents suffered a “targeted attack,” e.g., a malware attack aimed exclusively at their organization or small sub-population.

The targets of attack have also shifted, from computers and servers to online transactions. The nature of attacks has also become more extensive, including identity theft, key logging, phishing, dictionary attack, brute force attack, man-in-the-middle attack, and others. According to federal law enforcement authorities, identity theft is currently one of America's fastest growing crimes. Identity theft also represents the largest category of complaints received by the Federal Trade Commission. Consumer advocates, and security experts have stated that identity theft crimes will become more common as criminals become more expert and electronic transmissions become more wide-spread.

Key loggers and screen loggers are particular kinds of malware that track keyboard input and send the information they glean to the hacker back over the Internet. Malware can embed itself into user browsers as a small utility program, and into system files as device drivers. All these undermine consumer confidence in online transactions.

Passwords are the most common method used for online authentication. They are easy to use and have a very low implementation cost. However, users tend to select weak passwords, those that are easy to remember, and they are usually drawn from a relatively small dictionary. Such are vulnerable to brute-force/dictionary attacks, in that an attacker tries every possible password.

Security professionals have long advocated strong passwords that contain upper and lower case, mixed alpha numeric characters, and more than eight characters in length. The problem is that most users cannot remember these complicated passwords, and even the strongest of passwords are susceptible to phishing and keystroke logging attacks.

Two-factor and three-factor security measures can reduce the success rates of attacks. Passwords alone rely on a single-factor, e.g., what-users-know. Adding more factors, like what-users-have and who-users-are have long been known to improve security. What-users-have can be a hardware token, and who-users-are can be represented by a biometric like a fingerprint, photo, or signature.

Conventional password generators that create unique passwords only provide marginal security improvements. Computer-generated passwords are still vulnerable to brute-force attacks, but can be strengthened if they are very long, incomprehensible, or both.

Recent developments include multi-factor authentication, e.g., using physical tokens that generate a unique authentication code that must be entered in addition to a user password. PayPal and CitiBusiness are examples of online businesses using these devices. Such appears robust enough, but implementation carries a high price tag, and is extremely inconvenient for users who have to carry a token for every online account they need to access.

Phishing originally referred to account theft using instant messaging broadcasts, but the most common broadcast method used today is a deceptive email message. Users are sent urgent messages saying they need to verify account information, e.g., due to a system failure, fictitious account charges, undesirable account changes, new free services requiring quick action, etc. Thus users are told that they must re-enter confidential information to “protect” their accounts. Just the opposite is true, and yet many intelligent people fall for this scam.

Most users are also not aware that each online transaction creates many temporary, session and other files, and may not be deleted when the transaction is completed. If the transaction involved the use of a publicly-accessed computer, such as in a hotel's business center, these files can be accessed by vigilant hacker and the information in them can be abused.

The productivity benefits of providing remote access from any computer, such as virtual private networks (VPN), come with additional security concerns. For example, the transaction itself may be encrypted when a person accesses a network through an unmanaged PC at the conference or an airport, but afterwards, their sensitive information can linger inside. Secure socket layer (SSL) VPN sessions can leave cookies, browser histories, temporary files, and email attachments on the computer or in the browser cache. These will remain even when the session is over. A hacker with access to that PC can thereafter get access to sensitive company information, or even log-on to the corporate network itself.

Unsecured PC's leave the door open to bits of sensitive information they accessed on secured servers. Such PC's can be targeted in an attack, and each is more easily compromised than the secure server. Data theft is a widely used method of business espionage. Thieves profit from this by selling confidential communications, design documents, legal opinions, employee related records, etc.

### SUMMARY OF THE INVENTION

Briefly, a security method embodiment of the present invention comprises initiating a security token with a particular user through a personal computer client by accepting a personal identification number (PIN) as a code1 input, wherein a user is expected to remember the PIN in later accesses of the servers. And, generating a master key as code2 which does not need to be remembered by the user. Then, encrypting the code2 with a symmetric key cipher, using the code1 input as an encryption key, and storing the ciphertext in the security token. Later, registering the user with a USER_ID at a server with a SERVER_ID, and a password. And, obtaining the PIN from the user as a code1 which is used as a decryption key to decrypt the ciphertext back to its original code2. And, computing the password from the USER_ID, SERVER_ID, and code2. Afterwards, logging-on the user with a USER_ID at a server with a SERVER_ID, and a password.

An advantage of the present invention is that a method is provided to secure user access with webservers.

Another advantage of the present invention is a method is provided that makes it easy to log onto many different websites, each with strong password protection.

A further advantage of the present invention is a security token is provided for two-factor authentication.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1 is a functional block diagram of security token embodiment of the present invention;

FIG. 2 is a functional block diagram of a security business model based on a security device with an authentication code generation engine (ACGE) module, a user ciphertext, and a server requirement file;

FIG. 3 is a functional block diagram of an encryption processor using code1 as an encryption key to scramble code2 into ciphertext;

FIG. 4 is a flowchart diagram of an ACGE user account registration; and

FIG. 5 is a flowchart diagram of an ACGE user authentication.

### DETAILED DESCRIPTION OF THE PREFERRED EMBODIMENT

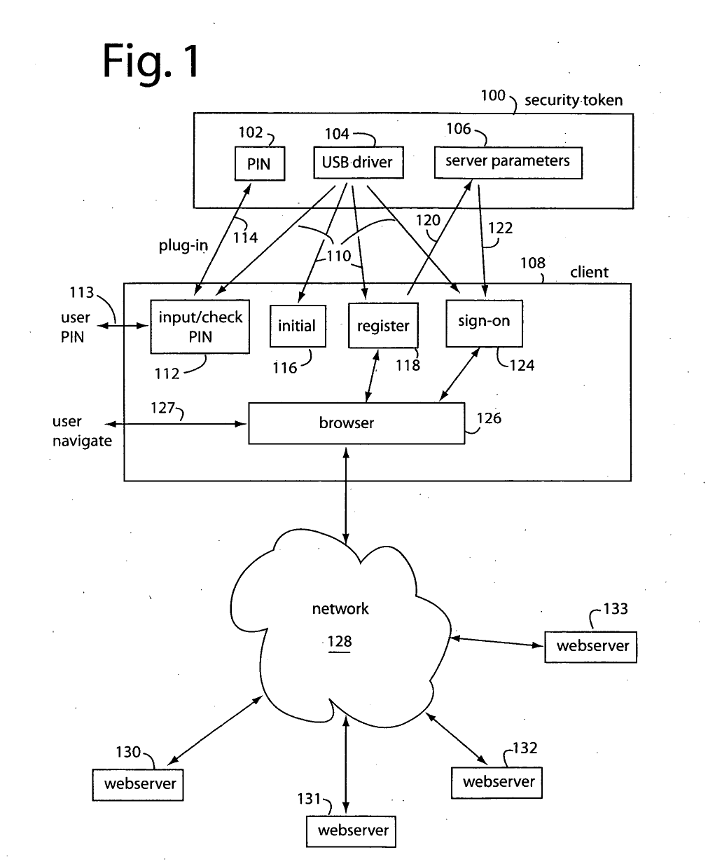

FIG. 1 represents a security token embodiment of the present invention, and is referred to herein by the general reference numeral 100. Such can be fully embodied in a software product. Here, security token 100 is implemented in this example, as a universal serial bus (USB) flash drive to operate with Microsoft WINDOWS and INTERNET EXPLORER equipped personal computers (PC's). It could also be embedded in a Smartphone, SD-Plus memory, Apple iPod, or other mobile device. Other browsers and operating systems are also possible, e.g., Firefox, Safari, Apple OSX, Microsoft WINDOWS MOBILE, Linux, etc.

Security token 100 includes a personal identification number (PIN) program 102 to request a PIN from a user, a USB driver 104, and a server parameter database 106. When the security token 100 is plugged into a USB port of a client computer 108, it automatically downloads 110 and runs several USB device drivers that include, e.g., a program 112 to input a user PIN 113 which is uploaded 114, a program 116 to initialize the security token 100, and a program 118 to help register the user at various webservers. The initialization creates a ciphertext 120 used to compute a server authenticator (sign-on password) 122 for use by a log-on device driver 124.

Program 112 will require a user to enter a PIN 113. If this is the initial use of security token 100, then program 112 will use PIN 113 as a key to encrypt master key (code2) and then store the ciphertext in security token 100. Thereafter, the user entered PIN 113 will be enable the ciphertext to be decrypted back into the original master key (code2) by program 116.

A browser 126 accepts user navigation 127 to surf through a network 128 to one of several webservers 130-133. For example, network 128 can be the Internet and webservers 130-133 can represent user sites like PayPal, CitiBusiness, eBay, CapitalOne Credit, Equifax, etc.

Program 118 will register the user with each of the several webservers 130-133 if the user signals it to do so, e.g., by typing in “*+” at the keyboard. Program 118 will detect and store webserver parameters in security token 100 that are specific to the user and each webserver 130-133. For example, rules that dictate acceptable user-ID and password syntax.

Registration program 118 can generate strong passwords automatically that are unique to each webserver 130-133. Such allows the user to simply output them during sign-on using only PIN 113 and a “**” keyboard command, for example. Such passwords are never stored, only generated as needed. Files and temporary storage are all cleaned up and sanitized immediately so no sensitive information can linger beyond the time it was actually needed.

In general, users can log in to multiple sites with one easy-to-remember keystroke, “**”. They do not need to remember different passwords for different sites. A personal single sign-on (PSSO) process manages password creation, storage, and recall. To prevent a user under a phishing attack from being compromised, PSSO performs a series of checks, and will alert the user if the site is suspicious. The passwords will be sent out only if the website is legitimate. All attempts to log keystrokes are trapped, to maintain user privacy and prevent data eavesdropping.

Man-in-the-middle phishing is harder to detect than many other forms of phishing. In these attacks hackers position themselves between the user and the legitimate website or system. They record the information being entered but continue to pass it on so that users' transactions are not affected. Later they can sell or use the information or credentials collected when the user is not active on the system.

In order to prevent a user coming under a phishing attack, a series of checks are made. Passwords are only released to a legitimate website, otherwise the user is alerted that the site is suspicious.

At the end of the online session, security token 100 removes cached information during the session from the PC. It intercepts all file-open, file-read and file write requests during the session so that all files on the endpoint are protected. Upon exit, security token 100 erases all working files and other data created during the session, e.g., using a computer data sanitization algorithm like that described in US Department of Defense Specification DoD.5200.22-M.

Security token 100 protects the user's data when used, and long after. It creates a special hidden directory of encrypted files, marketed as INVICTA™. Each file is encrypted using a strong encryption algorithm, and the directory is hidden whenever security token 100 is deactivated. The hidden directory and its encrypted files automatically reappear when security token 100 is activated. Unauthorized file access is therefore prevented.

Security token 100 copies user Internet Explorer favorites from a user default host computer to security token 100. Thereafter, users access them from any Windows-based computer wherever they go. A bookmark database in security token 100 allows only authorized users to access such Internet favorites. The bookmark database will not be left behind on the client computer.

Activating security token 100 requires a PIN entry from the user. At initialization, programs downloaded from security token 100 will generate a long sequence of random bits called master key and also referred to as code2. The code2 is encrypted using the code1 as encryption key to generate a user ciphertext which is stored in the security token.

PIN and master key are not stored on security token 100. Taking possession of the user ciphertext does not compromise the overall security, as the system requires the knowledge of the master key. It is not possible to hack the user accounts, as passwords in the clear are not stored on security token 100.

Security token 100 is easy to use. Site-specific strong password creation only requires the user to type “*+”. Password can thereafter be retrieved by typing “**”. The same keystroke works for multiple passwords on multiple domains.

The technology keeps track of all working files in a user session. It transparently intercepts all requests for file operations. Only operations on working files are permitted and performed, while all the original files in the host computer are kept intact. Upon completion of the working session, the method erases all working files and other data created in the session from the host computer, using the DoD.5200.22-M data sanitization algorithm.

Table-I represents ways to mathematically express encryption, decryption, pseudorandom function generation, and concatenation, in software embodiments of the present invention.

TABLE I

| | |
|---|---|
| e(k, m) | encryption of message m, with encryption key k, |
| | and a symmetric key encryption algorithm |
| d(k, c) | decryption of a ciphertext c, with decryption |
| | key k, and a symmetric key encryption algorithm |
| prf(k, m) | a keyed pseudorandom function, where k is a |
| | secret key and m is a message |
| x\|y | concatenation of messages x and y |
| [x] | indication that data x is optional |

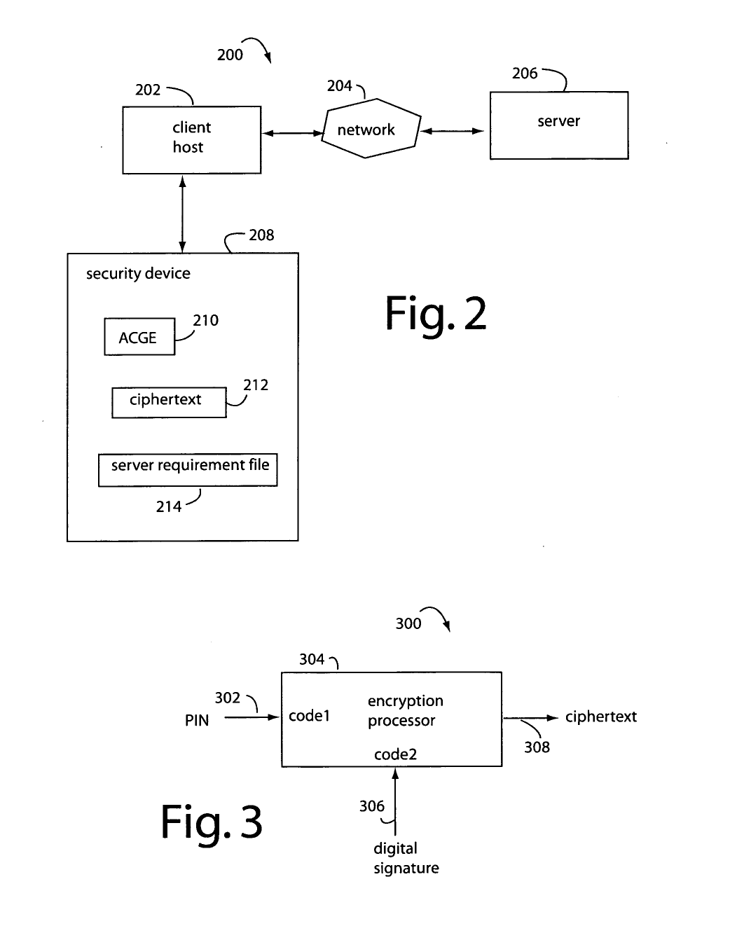

FIG. 2 represents a business model 200 for securing user transactions over computer networks. Business model 200 uses an available client host 202 to connect through a network 204 to a server 206. A security device 208 plugs into client host 202, and is preferably very portable and easy for a user to carry it and plug it into any personal computer the user may be visiting at the time and have available. Currently, USB flash drives fit this requirement very nicely. In future, other types of devices may also become popular and ubiquitous. Business model 200 is particularly advantageous if the client host 202 itself is not secure and subject to public use or access. E.g., as in an Internet cafe.

Security device 208 includes an authentication code generation engine (ACGE) module 210, a user ciphertext module 212, and a server requirement file 214. ACGE module 210 can be implemented as either hardware or software. E.g., an application specific integrated circuit (ASIC), or a firmware program that downloads to the client host for execution as a device driver or browser plug-in. ACGE 210 directs user initialization of the security device 208 itself with a particular user, account registration with various servers 206, authentication during sign-on later with servers 206, and account updates as necessary.

TABLE II
SERVER REQUIREMENT FILE

| Server ID | [User Name] | Format Requirement |
|---|---|---|
| Server ID 1 | [User Name 1] | Requirement 1 |
| Server ID 2 | [User Name 2] | Requirement 2 |
| Server ID 3 | [User Name 3] | [Default Requirement] |

Table-II represents how data is stored in the server requirement file 214. In an example server requirement file, a first column lists server's IDs, the second column lists user's names at different servers, and the third column lists each server's format requirement on the authentication codes. The user-names in the second column are optional. They are used to help a user remember their login names at various servers.

When a user wants to login into the user's account at a server with an identifier, Server_ID, such user accesses the server's login page, inputs their user name. The user's entering “**” will cause the strong password previously generated during registration to be regenerated for log-on.

FIG. 3 represent an initialization process 300 used with security device 208. The particular user of security device 208 is expected to enter a personal identification number (PIN) 302 during initialization and every time later when security device 208 is used to access a website from servers 206. The user will communicate such through the client host 202 attached to security device 208. PIN 302 must therefore be remembered by the user. It is used as a “code1” input to an encryption processor 304. A master key (code2) 306 is encrypted by encryption processor 304 using the PIN 302 as its key. The result is a user ciphertext string (U_Ciphertext) 308 that is stored in ciphertext module 212. U_Ciphertext=e(code1, code2). The master key (code2) 306 needs only to be input once by the user at device initialization and need not be remembered. So biometric measurements, random keystrokes, or mouse movements will satisfy the requirement that each ciphertext string 308 be unique to each user. PIN 302 is never stored, only ciphertext string 308 will be stored.

An attacker who tries to decrypt U_Ciphertext, e.g., using a brute-force attack of all possible candidate PIN 302 (code1) combinations, will not know when the decryption output is right.

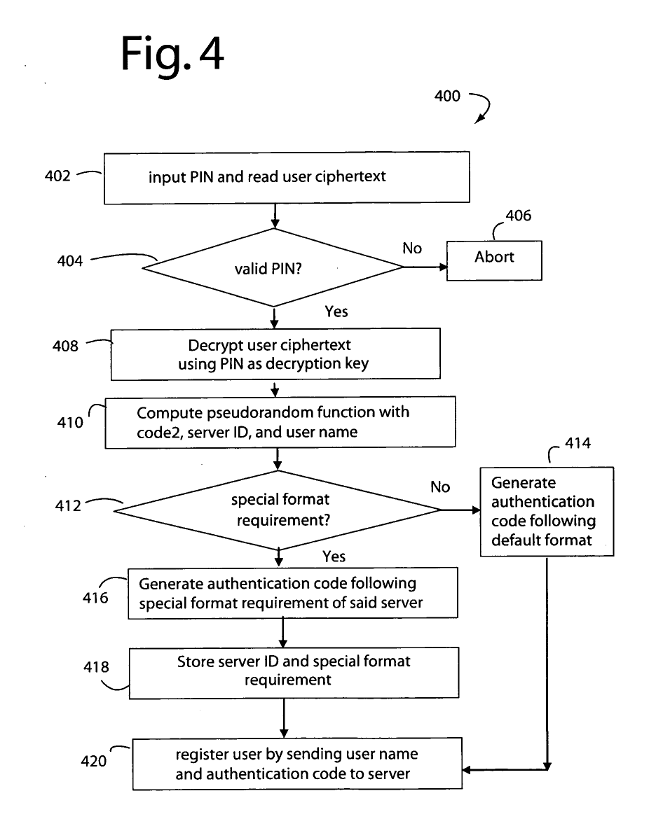

FIG. 4 represents a user account registration process 400. Suppose a user wants to open an account at a server identified as Server_ID. The user navigates to the server's user registration page via a browser, and then keys in a user name and enters “**”. Such regenerates the original strong password that was used during registration.

It may be desirable to have a means to detect human input errors when a user inputs the PIN (code1). In such case, check sum digits can be added to code1 that are computed, for example, according to the International Standard Book Number (ISBN) mod 11 Check, the Electronic Funds Transfer Routing Number Check, or the Verhoeff's Dihedral Group D5 Check.

In a step 402, an ACGE 210 is used to accept a code1 and check sum digits input from user at a keyboard. Step 402 automatically reads user “U_Ciphertext” from ciphertext module 212 in security device 208. A step 404 verifies the validity of code1, e.g., based on the check sum digits. If it is not valid, the process is aborted at a step 406. Otherwise, a step 408 uses ACGE 210 to decrypt the user ciphertext, using code1 as its decryption key. Such produces a second secret code (code2).

A step 410 uses ACGE 210 to compute a pseudorandom function, prf(code2|Server_ID|user name), using as input, code2, Server_ID, and user name. A step 412 checks if there is a special format for the authentication code that is required by the particular server. E.g., authentication codes must be exactly eight numerical digits. If there is no special format requirement, a step 414 uses a default format to generate an authentication code, prf(code2|Server_ID|user name).

Otherwise, a step 416 generates an authentication code for the user from prf(code2|Server_ID|user name), following a special format requirement of server. Then a step 418 stores the Server_ID and associated format requirement to server requirement file 214 (FIG. 2). Such server requirement file may also store the user name. Once an authentication code for the user is generated, a step 420 sends it along with user name to the server. The server will use the user name and authentication code to authenticate the user in future user authentication sessions.

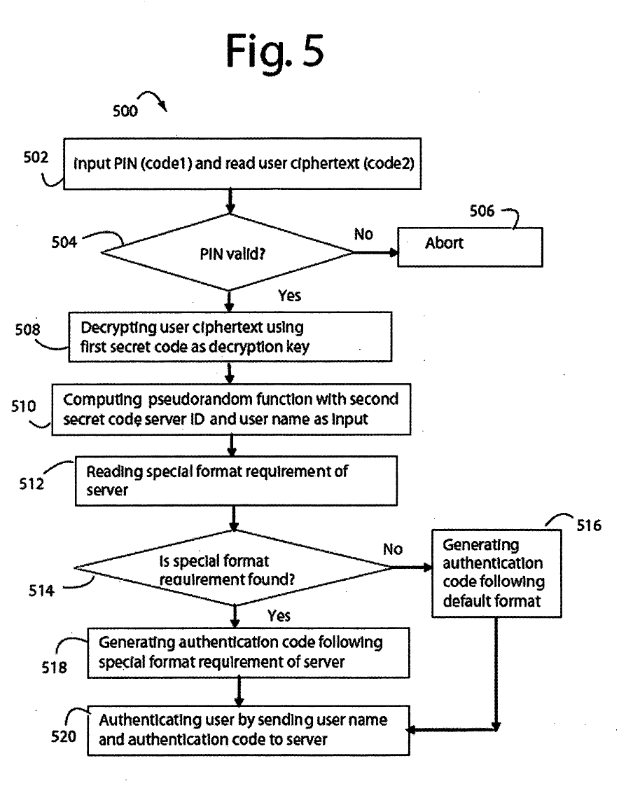

FIG. 5 represent a user authentication process 500. In a step 502, the ACGE 210 accepts a code1 and check sum digits from the user. It then reads user ciphertext U_Ciphertext 212. A step 504 verifies the validity of code1, based on the check sum digits. If it is not valid, the process is aborted at step 506. Otherwise, the ACGE 210 decrypts the user ciphertext at step 508, using first secret code (code1) as decryption key to obtain a second secret code code2). A step 510 computes a pseudorandom function prf(code2|Server_ID|user name) using code2, Server_ID, and user name as input. At step 512, any special authentication code format requirement is read from server requirement file 214.

At step 514, the ACGE 210 checks if a special format requirement on authentication code is found. If no, a step 516 generates an authentication code for the user from prf(code2|Server_ID|user name) following a default format. Otherwise, a step 518 generates an authentication code for user from prf(code2|Server_ID|user name) following the special format requirement of server. Once authentication code for user is generated, step 520 sends it out with the user name to server.

The security token 100 and security device 208 store only the ACGE module 210, user-ciphertext 212, and server requirement file 214. No user dependent data is stored in the client computer 108 or 202. Such makes user authentication easy, secure, and highly mobile.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A security token for authenticating a user to network servers, comprising:
a portable plug-in memory for a personal computer client connected to a network and having access to servers;
an initiation module disposed in the plug-in memory for initiating the security token with a particular user by accepting a personal identification number (PIN) as a code1 input, wherein said user is expected to remember said PIN in later accesses of said servers; and
an encryption process disposed in the plug-in memory for encrypting and storing a ciphertext output from a code2 input string, using said code1 input as an encryption key.

2. The security token of claim 1, further comprising:
a master key generated once by said user, but which does not need to be remembered by said user, and that can be input to said personal computer client as said code2.

3. The security token of claim 1, further comprising:
a registration module disposed in the plug-in memory for registering said user with a USER_ID at a server with a SERVER_ID, and a password;
a password generator for obtaining said PIN from said user as a code1 key to decrypt said ciphertext back to its original code2;
a pseudorandom function for computing said password from said USER_ID, SERVER_ID, and code2.

4. The security token of claim 1, further comprising:
an authentication module disposed in the plug-in memory for logging-on said user with a USER_ID at a server with a SERVER_ID, and a password;
a password generator for obtaining said PIN from said user as a code1 key to decrypt said ciphertext back to its original code2;
a pseudorandom function for computing said password from said USER_ID, SERVER_ID, and code2.

5. A security device for authenticating a user to servers on a network, comprising:
a plug-in portable device including at least one of a USB flash drive, Apple iPod, SD-Plus Memory, or Smartphone, for attachment to a personal computer client connected to a network and having access to servers;
an initiation device driver disposed in the plug-in portable device for initiating the security token with a particular user by accepting a personal identification number (PIN) as a code1 input, wherein said user is expected to remember said PIN in later accesses of said servers;
an encryption process disposed in the plug-in portable device for encrypting and storing a ciphertext output from a code2 input string, using said code1 input as an encryption key;
a master key generated once by said user, but which does not need to be remembered by said user, and that can be input to said personal computer client as said code2;
a registration device driver disposed in the plug-in portable device for registering said user with a USER_ID at a server with a SERVER_ID, and a password;
a password generator for obtaining said PIN from said user as a code1 key to decrypt said ciphertext back to its original code2;
a pseudorandom function for computing said password from said USER_ID, SERVER_ID, and code2; and
an authentication device driver disposed in the plug-in memory for logging-on said user with a USER_ID at a server with a SERVER_ID, and a password.

6. A security method for authenticating a user to servers on a network, comprising:
initiating a security token with a particular user through a personal computer client by accepting a personal identification number (PIN) as a code1 input, wherein a user is expected to remember said PIN in later accesses of said servers;
encrypting and storing a ciphertext output from a code2 input string, using said code1 input as an encryption key;
generating a master key which does not need to be remembered by said user, and that can be input to said personal computer client as said code2;
registering said user with a USER_ID at a server with a SERVER_ID, and a password;
obtaining said PIN from said user as a code1 key to decrypt said ciphertext back to its original code2;
computing said password from said USER_ID, SERVER_ID, and code2; and
logging-on said user with a USER_ID at a server with a SERVER_ID, and a password.

7. A system for authenticating users to a network of servers, the system including at least one user with a security token, and at least one server, a method for user initialization comprising:
accepting a first secret code and a second secret code from a user;
encrypting second secret code using a symmetric key encryption algorithm with first secret code as the encryption key;
storing the resulting ciphertext in a security token.

8. A system for authenticating users to a network of servers, system including at least one user with a security token, and at least one server, a method for user registration to a server comprising:
accepting a user name and a first secret code from a user and reading a ciphertext from a security token;
decrypting ciphertext using a symmetric key encryption algorithm with the first secret code as the encryption key to obtain a second secret code;
computing a pseudorandom function with second secret code, identifier of a server and possibly some other data as input;
if there is authentication code format requirement from said server, generating user's authentication code from output of pseudorandom function, authentication code being formatted based on authentication code format requirement;
writing said server's identifier to a file in said security token;
otherwise generating authentication code from output of pseudorandom function following a default format;
sending user name and authentication code to said server.

9. A method for authenticating users to servers in a system including at least one user with a security token, and at least one server, compromising:
accepting a user name and a first secret code from said user and reading a ciphertext from a security token;
decrypting ciphertext using a symmetric key encryption algorithm with the first secret code as the decryption key to obtain a second secret code;
computing a pseudorandom function with second secret code, identifier of a server and possibly some other data as input;
reading authentication code format requirement of said server from security token;
if the authentication code format requirement is found, generating said user's authentication code following authentication code format requirement;
otherwise generating said user's authentication code following a default format;
sending user name and authentication code to server.
